(19) United States
(12) Patent Application Publication
(10) Pub. No.: US 2018/0039756 A1
(43) Pub. Date: Feb. 8, 2018

(54) Narcotic Prescription Medication Dispenser

(71) Applicants: James Jerry Phipps, Cookeville, TN (US); Jesse Ryan Phipps, Cookeville, TN (US)

(72) Inventors: James Jerry Phipps, Cookeville, TN (US); Jesse Ryan Phipps, Cookeville, TN (US)

(21) Appl. No.: 15/229,048

(22) Filed: Aug. 4, 2016

(51) Int. Cl. G06F 19/00; G06F 21/32; A61J 7/04; G06F 21/62

(52) U.S. Cl. CPC G06F 19/3456; G06F 21/6245; G06F 21/32; A61J 7/0418; A61J 7/0445; A61J 7/0436

(57) ABSTRACT

A device which is a medication dispenser, when filling certain types of prescription drugs at the pharmacy, pharmacist will scan medication dispenser with radio frequency identification reader, the radio frequency identification tag/chip which will be located inside the medication dispenser, When RFID tag/chip is scanned by pharmacist with RFID reader when prescribed outpatient comes into the pharmacy to fill a new prescription for an individual outpatient medication dispenser, RFID tag/chip will unlock and lock down medication dispenser through electronic lock. Pharmacist will then load number of prescription medication. RFID tag/chip will also comprise and hold of each individual outpatient's name, prescription information, such as type of medication, doctor prescribed hourly dosage, and quantity of daily and monthly medications schedule, and medication dispenser's location also comprising of computer chip and computer interface transmit through software on pharmacist computer will send and receive patient information, type of medication, daily dosage schedule, send data to and from pharmacy computer, and monitoring service system. Pharmacist through software will synchronized each patient's medication dispenser through computer chip/timer to dispense medication only as doctor prescribed hourly dosages, also comprising in software patient would entered into database with each outpatient having an unique narcotic number for narcotic prescription drugs each time they fill new prescription to reduce or prevent doctor shopping This device a medication dispenser was designed to replace standardized prescription pill bottle when feeling certain types narcotic or other types of prescription medication at their local pharmacist. Where outpatient will never have access to full prescription and medication dispenser will dispense automatically on doctor prescribed hourly dosage once outpatient leaves the pharmacy and goes to house, this will reduce dramatically the risk of doctor shopping, misuse, abuse, and black-market sells. The medication dispenser will also comprise of a touchscreen display for patient interaction to set up visual, sound or down-loadable application for smart devices alert outpatient there doctor prescribed hourly dosage is time to dispense or an alert letting outpatient know and other options and touch screen will display patient and prescription information and FDA medication warnings, a sort digital RX sticker, also this medication dispenser or device comprises a fingerprint Id scanner/reader for patient identification to access touchscreen for certain patient information display and patient must scan fingerprint to insure dispenser only dispenses medication when patient is present also and other setting and on touch screen an emergency button to activate if outpatient is have any common emergency with microphone and speaker if emergency button is activated for patient interact with monitoring service which can also send patient to 911 operator or send appropriate first responders. There will be sensors comprised near electronic lock and other security risk locations in dispenser, in which monitoring service can detect tampering and other issues.

### CROSS REFERENCE

This Utility Non-Provisional application and Invention is cross referenced to co-pending design Non provisional application as well as a utility provisional application of the Narcotic Prescription Medication Dispenser.

The Narcotic Prescription Medication Dispenser is a pharmaceutical medication dispenser. When filling narcotic medication to replace standardized pill bottles filling narcotic prescription at pharmacy. The Narcotic Prescription Medication Dispenser will only be opened, locked down, and medication loaded only by pharmacist.

### BACKGROUND OF INVENTION

The Narcotic Prescription Medication Dispenser is a pharmaceutical medication dispenser when filling narcotic medication the standardized pill bottles will be replace with Narcotic Prescription Medication Dispenser when filling narcotic prescription at pharmacy. This will reduce or prevent doctor shopping, abuse, misuse, black market sell and crime associated with narcotic prescription medication. Patients who abuse the narcotic prescription drugs whom then have to be put in a rehabilitation facility, in which the insurance companies and or government assists paid in full or a portion of the treatment, emergency room admission. Narcotic prescription medication abuse is a epidemic that is now killing more people in U.S. Then automobile accidents in which the Narcotic Prescription Medication Dispenser correlates with automobile accidents in another way, in 1968 insurance companies petitioned U.S. Congress to make mandatory seat belt laws for safety to reduce accidents from killing/injuring motorist, saving insurance companies billions of dollars and countless number of lives, similar to the Narcotic Prescription Medication Dispenser that when implemented will save federal, state, and private insurance companies tens of billions of dollars annually by reducing or prevent doctor shopping, insurance fraud, abuse, misuse, black market sell and crime associated with narcotic prescription medication, patients who abuse the narcotic prescription drugs whom then have to be put in a rehabilitation facility, in which the insurance companies and or government assists paid in full or a portion of the treatment, emergency room admission life flights and life insurance policy pay outs due to accidental overdose but not only saving money but a countless number of lives. Inventors will be working closely with insurance companies, petitioning and lobbying Congress to make mandatory the Narcotic Prescription Medication Dispenser that when filling all or certain types of lethal narcotic prescriptions.

### SUMMARY

The objective Narcotic Prescription Medication Dispenser and method of uses is to lock down narcotic prescription medication in a secure medication dispenser, with the Narcotic Prescription Medication Dispenser and method implemented patients will never have access to their full prescription decreasing the risk of overdose, misuse, abuse and black market sells and crime associated with narcotic prescriptions, also patients will never have access to there full prescription, saving federal, state, and private insurance companies billions of dollars, but not only saving money but lives, instead of standardize pill bottle when filling narcotic medication patient will be issued Narcotic Prescription Medication Dispenser that will dispense medication only as doctor prescribed.

### DRAWING DESCRIPTIONS

FIG. 1 The top view with lid open of the Narcotic Prescription Medication Dispenser the left is the open lid underneath the open lid is a RFID tag or bar code system which will hold patient information, location and will unlock and lock down the dispenser once scanned in pharmacy can type in prescription information like patient daily dosage, number of monthly dosage into software to send computer chip in patient dispenser to set timer based on dosage. the electronic lock mechanism is lock and unlock maybe held on computer chip or RFID Tag that is only locked or unlocked by pharmacy through computer chip and software or with RFID reader when scanned, and on right side of this drawing is where the pharmacist/pharmacy will load narcotic medication into a enclosed downward sloped area with opening in the middle for medication to easily slide into the medication holding area. On the right where dispenser closes is the electronic lock to lock down and or opening dispenser which when RFID tag/chip is scanned.

FIG. 2 Outside left side view of dispenser on bottom left corner is a charger input along with detached with regular power outlet 3 Ft. charging cable (not shown).

FIG. 3 Inside front view of dispenser like in config. 1 once pharmacist/pharmacy loads medication through into enclosed downward sloped area with opening in the middle for medication to easily slide into medication holding area with opening in the bottom of the medication holding area with flap mechanism that will only allow a certain amount of medication into enclosed medication area to lining up medications down to one row with slot for medication to line up in one row with flap mechanism with opening that drops one tablet/capsule onto a conveyor wheel which is synchronized to computer timer that makes wheel turn to dispense medication as doctor prescribed, in which medication will not dispense unless on the left side bottom is battery and a back battery on bottom of dispenser will have computer chip for software, finger print scanner, timer for dispensing medication, down loadable application for smart phone/tablet and computer interface to send and receive information from and to computer chip and touch screen display. On right side in middle of dispenser in speaker for voice activation, emergency contacting monitoring call center and optional sound and visual to alert patient that medication is being dispensed. The Narcotic Prescription Medication Dispenser is approximately 3″ to 5″ in width×3″ to 5″ in height×2″ thick. It may be made to different dimensions to accommodate medications of varying sizes.

FIG. 4 Outside front view of dispenser is touch screen display and underneath in the middle below touch screen is finger print scanner for finger print identification scanner to insure patient is present before dispensing, On the right side of the finger print scanner is and bottom right corner of dispenser is medication flap to retrieve medication. There will be a speaker on the right side of the finger print scanner for monitoring call center to contact patient for any type of emergency/problem also will have emergency button on touch screen display for patient can contact monitoring call center, also setting for sound and visual alert or downloadable application for smart devices and FDA standard medication warnings also on touch screen display.

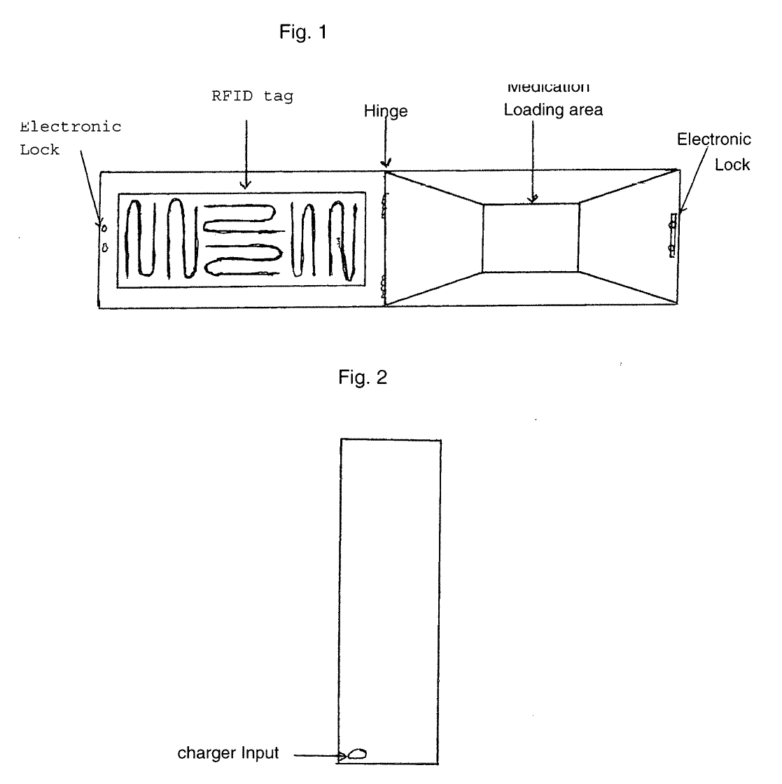

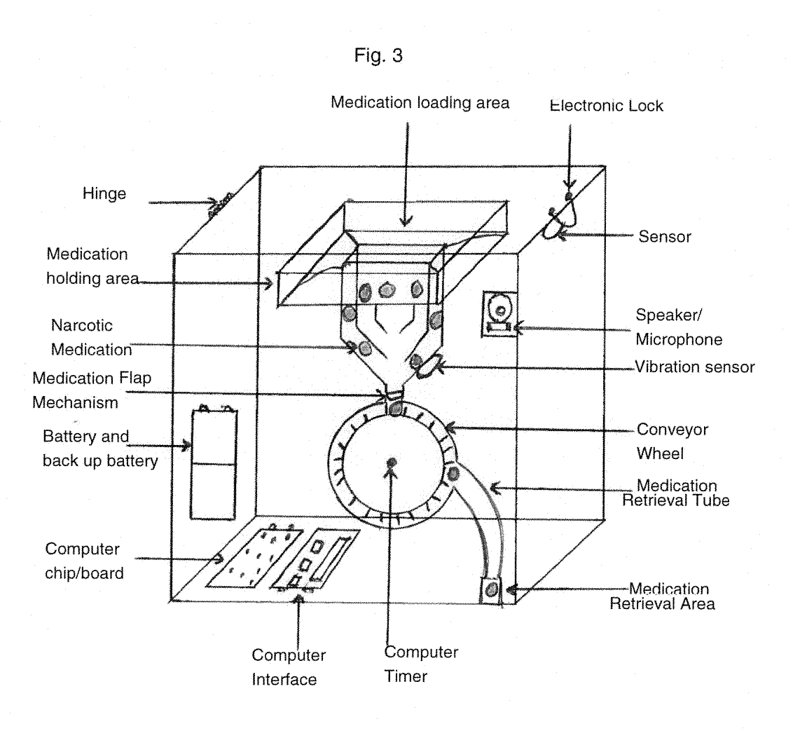

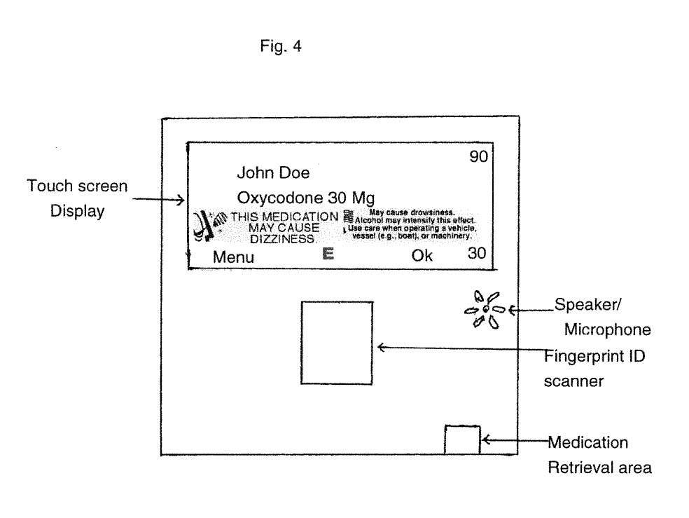

### DESCRIPTION

The Narcotic Prescription Medication Dispenser will have a RFID tag holding patient information, location, and prescribed dosages. The pharmacist/pharmacy will scan RFID tag with reader for dispenser to open to load medication then again to lock down before patient pick up at pharmacy. A computer chip and timer to accurately dispense medication as doctor prescribed. A computer interface to operator touch screen display for patient interaction giving the patient information also remaining number of medication and set up for down-loadable application for smart phones and or tablets or alert text message letting patient know dispenser is ready to dispense and Fingerprint ID scanner for medication to only dispense when patient is present and to see certain information on computer screen. A speaker/microphone for a voice command once emergency button is pushed on computer screen and if there is any type of common emergency it will then send patient to monitoring call center company to help patient with emergency or transfer patient to 911 operator sensor near electronic lock and other locations can detect tampered dispenser which can also alert monitoring center. There will be a clear medication flap to easily open to retrieve medication once fingerprint has been scanned to then dispense medication, only when patient is present. after scanning fingerprint patient will be able to see dispensed medication in clear medication retrieval area of dispenser. Patient will never open, lock down, or have access to narcotic prescription medication computer chip software and interface with nation-wide database to reduce or prevent doctor shopping, computer interface to send and receive all patient information from pharmacist computer software to set timer patient name type of narcotic medication number of tablets/capsules and if prescribed dosage will set on every 4, 6, 8, or 12 hour dispensing schedule, for narcotic medications such as oxycodone, hydrocodone, suboxone, methadone, morphine and more. There will be downloadable application for smart phones and tablets or alert text message also setting for sound and visual notification will be available to notify patient it is time for dosage to dispense, then patient will scan fingerprint on fingerprint ID scanner to dispense medication only when patient is present and patient will have a designated amount of time to scan in for that particular daily dosage before that dosages is no longer obtainable. RFID tag will hold patient information such number of tablet/capsules remaining prescribing doctor, location and pharmacist scans with RFID reader when scanning RFID tag or chip it will lock and open electric locking system. A vibration sensor attached to medication holding area to prevent medication jamming and prevent malfunctions of dispenser. There will also sensors through out dispenser to can detect tampering, hard hits, unauthorized opening and a speaker and microphone for monitoring call center can interact with patient if any of these problems occur and if patient has an emergency once fingerprint ID is scanned and emergency button is activated monitoring call center can help with issue or transfer a 911 operator to patient's dispenser.

Once pharmacist scans RFID tag with RFID reader dispenser will open then will load in number of prescribed medication by pharmacist then on pharmacy computer patient's information data will be entered then when scanned to lock down dispenser information will also to dispenser, then narcotic medication in the narcotic Prescription Medication Dispenser will be ready for patient pick up, monitoring call center or pharmacy personnel will assist first time patient in dispenser set up. Replace standardized pill bottles and patient will never have access to there full prescription.

When patient is given prescription by there doctor they will then take there prescription to there local pharmacy, pharmacist will then fill medication in Narcotic Prescription Medication Dispenser instead of standardized pill bottle they will then scan RFID tag inside the Narcotic Prescription Medication Dispenser with there RFID reader which will unlock or lock down, the Narcotic Prescription Medication Dispenser, Then prescription will then be loaded and filled by pharmacist, pharmacist will enter patient information and data which will send and receive information to patient's Narcotic Prescription Medication Dispenser. There will also be a nationwide database in which patient will have there own narcotic number or some type of identification number to decrease or prevent doctor shopping. Pharmacist will then scan RFID tag to lock down Narcotic Prescription Medication Dispenser then will be ready for patient pick up at pharmacy. Once patient leaves the pharmacy there dispenser's computer timer will be set and synced with conveyor wheel holding medication to turn and release one dosage at a time, also give patient a certain amount of time to scan fingerprint scanner to retrieve there narcotic medication there will be a downloadable application for smart phones and tablets or text message alert to let patient know there dosages is ready and after a certain time medication will no longer be available, and patient will never have access to full prescription and if the dispenser is tampered with there will be sensors throughout to alert monitoring call center about the tampering also this dispenser will be made available to other patients such as senior citizens who may have memory issues or other problems keeping up with there medication to prevent double dosage of medication other then narcotics such as heart, blood pressure and just to name a few types of medication, once medication is ready and alert has been sent patient will scan fingerprint on fingerprint ID scanner to only dispense when patient is present and emergency button for any form of an emergency or issue for patient to push to send them to the monitoring company call center dispenser also has speaker and microphone to interact with call center when emergency button is activated where call center can also direct patient straight to 911 operator. Also touchscreen display for patient interaction where patient can know all there prescription information type of medication to remaining number of medication, days left on the prescription and more, once patient leaves pharmacy dispenser will dispense medication as doctor prescribed, once prescription date has ended any medication that had not been retrieved will be discarded by pharmacy. Inventors will petition U.S. Congress to make Narcotic Prescription Medication Dispenser mandatory There will be provisions put in place if dispenser is continues to be tampered, as well as, other provisions to hinder tampering and insure patient's safety and safety of other by Congress, and Dept. of Justice.

RFID tag is scanned to unlock and lock down with an electronic lock Narcotic Medication Dispenser to be then fill prescription by pharmacy. Pharmacist will load medication in the medication loading area computer chip board through software on pharmacist computer will send patient information type of medication daily dosage schedule computer chip/interface send to dispenser to set timer medication holding area has vibration sensor to make small vibration to prevent any jamming or malfunction. A flap mechanism between medication holding area and conveyor wheel which hold one tablets/capsule at a time to drop into medication retrieval tube down to medication retrieval area cellphone type battery and back up battery or lifetime batteries of another type fingerprint Id scanner for patient identification scanner and to dispense only once patient scans to insure patient is present touchscreen for patient information display and patient interaction also an emergency button on touchscreen display when pushed activates microphone and speaker for once emergency button is activated patient and interact with monitoring company call center which can also send patient to 911 operator sensors will be place near electronic lock system and through out dispenser that detects tampering with dispenser. The Narcotic Prescription Medication Dispenser is a pharmaceutical Prescription Medication Dispenser designed to replace standardized pill bottles when

filling narcotic prescription medication at the pharmacy. Narcotic Prescription Medication Dispenser is a secure medication dispenser that is opened medication loaded then locked down by pharmacist, patients will never have access to there full prescription to reduce and prevent misuse, abuse, insurance fraud, doctor shopping and black market sells of narcotic prescription medication. When patient is given prescription by there doctor they will then take there prescription to there local pharmacy, pharmacist will then scan RFID tag/chip Narcotic Prescription Medication Dispenser with there RFID reader which will unlock the Narcotic Prescription Medication Dispenser, Then prescription will then be filled by pharmacist, pharmacist will enter patient information into software on there computer which will send information to patient's Narcotic Prescription Medication Dispenser. There will also be a nationwide database where patients will have there own narcotic number to decrease and or prevent doctor shopping. Pharmacist will then scan RFID tag/chip with RFID reader to lock down Narcotic Prescription Medication Dispenser then will be ready for patient pick up at pharmacy. Once patient leaves the pharmacy there dispenser timer will be set through software and give patient a certain about of time to scan fingerprint ID scanner to retrieve there narcotic medication there will be a down loadable application for smart phones and tablets or text message alert to let patient know there dosages is ready and after a certain time medication will no longer be available, and patient will never have access to full prescription and if the dispenser is tampered with there will be sensors throughout to alert monitoring call center about the tampering also this dispenser will be made available to patients such as senior citizens who may have memory issues or other problem keeping up with there medication to prevent double dosage of medication other then narcotics such as heart, blood pressure and just to name a few types of medication, once medication is ready and alert has been sent patient will scan fingerprint on fingerprint identification to only dispense when patient is present and emergency button for any form of an emergency or issue for patient to push to send them to the monitoring company call center dispenser also has speaker and microphone to interact with call center where call center can also direct patient straight to 911 operator. Also touchscreen for patient interaction where patient can know all there prescription information type of medication to remaining number of medication, days left on the prescription and more, once prescription date has ended any medication that had not been retrieved will be discarded by pharmacy to keep for leftover medication to be sitting in patient medicine cabinet for friend, child, or grandchild to then have access to medication. There will be provisions put in place if dispenser is continues to be tampered, as well as, other provisions to insure patient's safe and others. 3 ft charger standard cell phone charger not shown in drawing. The Narcotic Prescription Medication Dispenser and method (co-pending utility application) appeals to doctors, patients, insurance companies, caregivers as a way to control and accurately dispense narcotic medications. This represents a significant consumer base and the unique design and utility method of the Narcotic Prescription Medication Dispenser makes it both appealing and marketable on a national appeal. The Narcotic The Narcotic Prescription Medication Dispenser/Method will be issued to all or certain types narcotic prescription patients by their local pharmacist/pharmacy locked down and open only by pharmacist/pharmacy dispenser will dispense to patient only as doctor prescribed. The Narcotic Prescription Medication Dispenser appeal for use of narcotic prescription medication patient, suboxone, methadone, and opioid and other narcotic prescribed patients, or elderly patient that forgets if they have taken, preventing double dosing also federal, state and private insurance companies

1. A device/medication dispenser for individual outpatient prescription medication dispensing.

2. The device/medication dispenser from claim 1 wherein medication dispenser intended to replace standard
prescription pill bottle for certain type of narcotic or other types of prescription medication

3. The device/medication dispenser from claim 1 wherein medication dispenser would be used just like standardize prescription pill bottle for outpatient prescription patient s to take home for medication dispenser to on doctor prescribed hourly dosage.

4. The device/medication dispenser from claim 2 wherein medication dispenser will dispense doctor prescribed hourly dosage once outpatient fills there prescription and leave the pharmacy.

5. The device/medication dispenser from claim 3 wherein and dispenses medication only on doctor prescribed hourly dosage.

6. The device/medication dispenser from claim 3 wherein and outpatient will never have access to the full prescription.

7. The device/medication dispenser from claim 3 that has sensors near electronic lock and other security risks
areas inside medication dispenser to detect tampering which would be comprising through monitoring service.

8. A device/medication dispenser comprising of a radio frequency identification tag or chip and reader.

9. The device/medication dispenser from claim 8 wherein RFID tag/chip once scanned by pharmacist will unlock or lock down dispenser through electronic lock

10. the device/medication dispenser from claim 8 wherein RFID tag or chip will send and receive patient's prescription information and location to patient's individual dispenser to pharmacy's and monitoring services computer a through software comprising through computer chip and interface.

11. The device/medication dispenser from claim 8 through RFID a Monitoring service can detect tampering to help patient if emergency and giver patient location and other details.

12. A device/medication dispenser comprising a touch screen display

13. the medication dispenser from claim 12 wherein medication dispenser with touch screen display giving outpatient name, prescription information, and FDA medication warnings. (digital Rx label)

14. The device/medication dispenser from claim 11 touch screen display have options from visual and sound alert to let patient know there doctor prescribed hourly dosage is ready to dispense.

15. The device/medication dispenser from claim 11 touch screen display with emergency button to activate in case of any common emergency where monitoring service can help patient or send appropriate first responders to patient location.

16. The device/medication dispenser from claim 11 wherein touch screen display an options for a down-loadable for smart devices to alert patient when medication is ready for refill or time for doctor prescribed hourly dosage is ready to dispense.

17. The medication dispenser from claim 11 wherein touch screen display for patient interaction to set all options

18. A device/medication dispenser comprising an finger print identification scanner/reader

19. The device/medication dispenser in claim 18 wherein with finger print identification scanner has to be scanned to insure patients is present before dispenser will dispense medication on doctor prescribed hourly dosage.

20. The device/medication dispenser in claim 19 wherein that dispenses only on doctor prescribed hourly dosage that only dispenses medication to patient once fingerprint scanner is scanned and patient's fingerprint is verified. Pharmacy personnel would help patient with fingerprint scanner/reader set up.
